(19) United States
(12) Patent Application Publication
(10) Pub. No.: US 2015/0194064 A1
(43) Pub. Date: Jul. 9, 2015

(54) AUDIOVISUAL COMMUNICATION AND LEARNING MANAGEMENT SYSTEM

(71) Applicant: SkillFitness, LLC, Minneapolis, MN (US)

(72) Inventors: William Young, Plymouth, MN (US); Wilson Garland, St. Louis Park, MN (US)

(21) Appl. No.: 14/594,074

(22) Filed: Jan. 9, 2015

Related U.S. Application Data
(60) Provisional application No. 61/925,622, filed on Jan. 9, 2014.

(51) Int. Cl. G09B 5/10; G06F 17/22

(52) U.S. Cl. CPC G09B 5/10; G06F 17/2247

(57) ABSTRACT

An audiovisual communication and learning management system enabling users to succinctly communicate specific, learned skills through video, audio, and other visual means on a networked device. More specifically, a system that enables a first user to receive knowledge about an area, that activates a camera or audio equipment, that enables the first user to create an artifact by using the camera and audio equipment, and that enables the first user to communicate the user's learned knowledge to a second user by sending the recorded video or audio content, in the form of the artifact, to the second user.

### CROSS-REFERENCE TO RELATED APPLICATION

This application claims the benefit of U.S. Provisional Application No. 61/925,622 filed Jan. 9, 2014, titled MOBILE LEARNING APPLICATION.

### FIELD OF THE INVENTION

The present invention generally relates to an audiovisual communication and learning management system that enables users to create, share, interact with and manage skill-related content through video, audio, and other visual means.

### BACKGROUND OF THE INVENTION

Traditional digital learning systems, whether client- or server-based, often involve video content pushed to the user in a course format. While convenient for the host, such systems often fail to engage content recipients. Users often do not pay close enough attention to the information they are exposed to and thus do not retain it. This results in the loss of valuable time for both the host and the user. In many industries, the information that is provided to users is important, such as critical technical or skill-related content, and could offer considerable benefits to the user if absorbed appropriately. Therefore, an audiovisual communication and learning management system is needed that engages users and allows them to absorb, retain, and later use as much information as possible.

### SUMMARY OF THE INVENTION

The audiovisual communication and learning management system described herein provides improved training exercises for a variety of market sectors. More specifically, the system can provide users with access to short-duration training exercises or activities delivered as video or audio content. The content can be stored in an application in the cloud, and users can access the application, and, therefore, the content, through a mobile device, web browser, or any other device connected to the Internet. In some cases the content may be downloaded to the mobile device, web browser, or other Internet-connected device to temporarily allow for offline availability. The content can be viewed directly in the application, web browser, or other Internet-connected device. The content can further be customized and managed by an administrator through the mobile application or a web-based content management system (CMS). Users consume content and generate new content to practice skills, complete activities, share knowledge or ideas, and provide feedback to other users.

Reference is made throughout the present disclosure to certain aspects of the audiovisual communication and learning management system described herein. Such references to aspects of the presently described audiovisual communication and learning management system do not limit the scope of the disclosure. Additionally, any examples set forth in this disclosure are not intended to be limiting and merely set forth some of the many possible embodiments for the disclosed audiovisual communication and learning management system. It is to be understood that the phraseology and terminology used herein are for the purpose of description and should not be regarded as limiting.

### BRIEF DESCRIPTION OF THE DRAWINGS

FIG. 1 is an exemplary user dashboard.

FIG. 2 depicts a content navigation hierarchy.

FIG. 3 illustrates one embodiment of thematically categorizing skills and competencies.

FIG. 4 depicts one method of sharing captured Attempts with other users.

FIG. 5 depicts one method of sharing captured Attempts with other users.

FIG. 6 depicts one method of sharing captured Attempts with other users.

FIG. 7 depicts one method of sharing captured Attempts with other users.

FIG. 8 is an example screen wherein a user that shared an Attempt can review and rate the feedback.

FIG. 9 illustrates a community screen where Attempts can be shared.

FIG. 10 is a schematic diagram depicting the system architecture.

FIG. 11 is a schematic block diagram depicting one embodiment of a user process flow.

FIG. 12 is a schematic block diagram depicting one embodiment of a manager process flow.

FIG. 13 is a schematic block diagram depicting an example computing system used in accordance with one embodiment of the present invention.

### DETAILED DESCRIPTION

The present disclosure relates to an audiovisual communication and learning management system that includes short-duration training exercises delivered as video or audio content streamed from a cloud-based content management system (CMS). Various embodiments of the audiovisual communication and learning management system will be described in detail with reference to the drawings, wherein like reference numerals represent like parts and assemblies throughout the several views. Reference to various embodiments does not limit the scope of the audiovisual communication and learning management system disclosed herein. While the system is described herein as applying to sales training exercises, it is capable of functioning in other distinct market sectors such as, but not limited to, general training exercises, presentation training, physical exercise, health and wellness, music instruction, theatrical performance, human resources and compliance, and leadership development.

Any examples set forth in this specification are not intended to be limiting and merely set forth some of the many possible embodiments for the audiovisual communication and learning management system. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

The disclosed audiovisual communication and learning management system is a system of several core components, connected together as illustrated in FIG. 10. The database 1004, for example CMS, business layer 1006, web application 1008, and web services 1010 are located within the server environment 1002. The business layer 1006 can be connected to the database 1004, web application 1008, web services 1010, user information 1012 (for example, CRM, LMS, or HRIS), file storage 1014 (for example, Amazon S3), external content source 1016, and incentive and point redemption system 1018. Web clients 1020, such as administrators and system operators, can access the web application 1008 through a desktop or laptop 1022. Mobile clients 1024, such as users, Managers, Coaches, and trainers/instructors, can access the web services 1010 on an operating system, such as, but not limited to, iOS 1026, Android 1028, and Windows 1030, or other web browser 1032.

The content from the audiovisual communication and learning management system described herein is delivered as non-course-based training exercises that support skills or competencies and can be organized thematically into skill, competency, or topic areas. Content can also be delivered as user assignments or activities organized thematically that support specific organizational objectives and cause users to engage with and share knowledge, ideas, or best practices with other users. This organization of learning content, such as video content can allow for easy navigation and access to the content in discrete chunks. It can also allow for tracking of progress and engagement broadly or at the level of individual training exercises or activity task units. The training exercises or activities can also be categorized as different levels reflecting differences in difficulty or complexity.

The categorization of exercises or activities into levels can allow for the tracking of user interaction with the audiovisual communication and learning management system, including user performance, which can facilitate completion of skills. In one embodiment, a user views exemplar skill-related video content, such as a video demonstration of a personal interaction, and then utilizes a device (or PC) camera to record a corresponding video segment. The user may then review and compare the host-provided video content with the user's corresponding content.

Once a minimum number of exercises or activities at similar level has been completed, the system may be programmed to designate “certification” in that particular base of knowledge. FIG. 2 illustrates an example of the content navigation hierarchy wherein a user can become certified in a broad skill 202 once the user completes a skill area 204 comprised of several exercises, activities, or tasks 206. For example, the broad skill 202 may be learning how to create a foundation with a customer and the skill areas 204 within that broad skill 202 may include introducing yourself, knowing your customer, and knowing the process. Each skill area 204 may further include several exercises, activities, or tasks 206 which, for a skill area 204 such as introducing yourself, may include exercises, activities, or tasks 206 such as describing who you are, explaining why you are there, understanding the importance of time, and gaining client agreement. The results of exercises, activities, or tasks 206 and the completion of “certification” are tracked within the system.

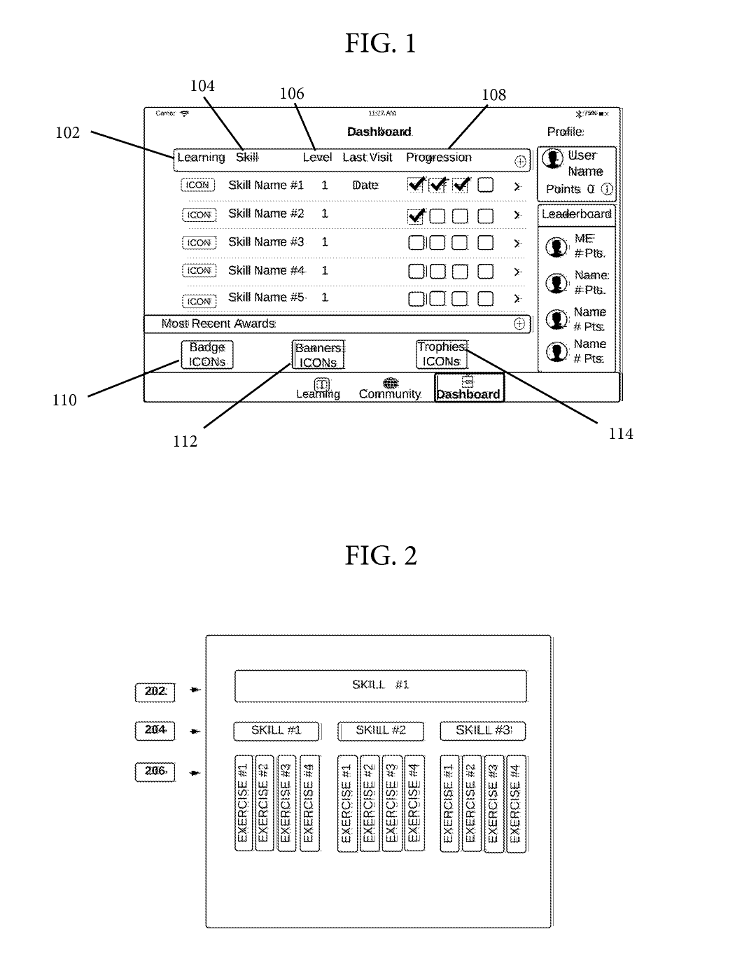

FIG. 1 illustrates an example of how badges and certifications are displayed to a user when the user completes certain exercises, activities, or skills 206 or certain skill areas 204. The same tracking and completion information can be passed to a learning management system (LMS), customer relationship management system (CRM), or human resource information system (HRIS), or other proprietary system that organizations use to track employee development, engagement, or performance through a customized application program interface (API).

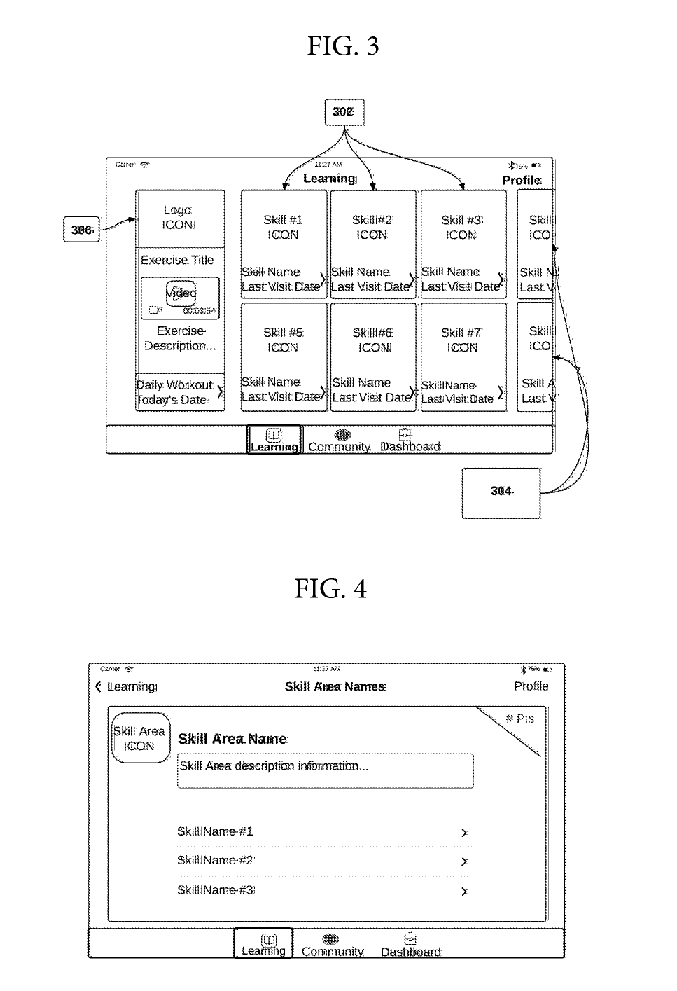

Within the learning component of the system, the skill, competency, or topic areas 302 can be categorized thematically into different types of content types 304 such as sales skill training, product training, process training, or other grouping of an organization's choosing. For example, as illustrated in FIG. 3, Skill #1, Skill #2, Skill #3, and Skill #4 maybe categorized as one content type 304, while Skill #5, Skill #6, Skill #7, and Skill #8 may be categorized as a second content type 304. This categorization of content allows for the delivery of different content types 304 to different users based on their profile or provisioning within the system. In some embodiments, companies that use the system can personalize the appearance of the user interface, wherein a company logo 306 and color scheme can be set so that they are displayed for any of the company's employees who use the system.

Each training exercise, activity, or task 206 can include a title, a description, learning or performance objectives, instructions, and “Expert” content that can include, but is not limited to, a video, presentation, or other digital document. Users can be given an Assignment that reflects specific objectives and instructions detailed with each exercise, activity, or task 206. Completing the Assignment typically involves using the system to create a video, audio file, document, or other format Artifact. The disclosed audiovisual communication and learning management system is designed to allow Artifacts to be created by the individual user in the system through the use of native features of the device including the camera, microphone, and/or keyboard in such a way that it shows or records the user attempting the training exercise, activity or task 206. Further, users can create more than one Attempt. The exercise, activity, or task 206 can also be configured to display certain documents, information, or other content to user while the user is in the process of creating an Attempt, which is created for the purpose of demonstrating an element of a skill or competency.

In some cases, the Artifacts are uploaded as documents or created through customized forms, surveys or assessments that capture the user's response to a given exercise, activity, or task 206. In the current application, these Artifacts are called Attempts. Artifacts can be created asynchronously with users working independently, or synchronously with users interacting together at the same time in person or virtually through the device.

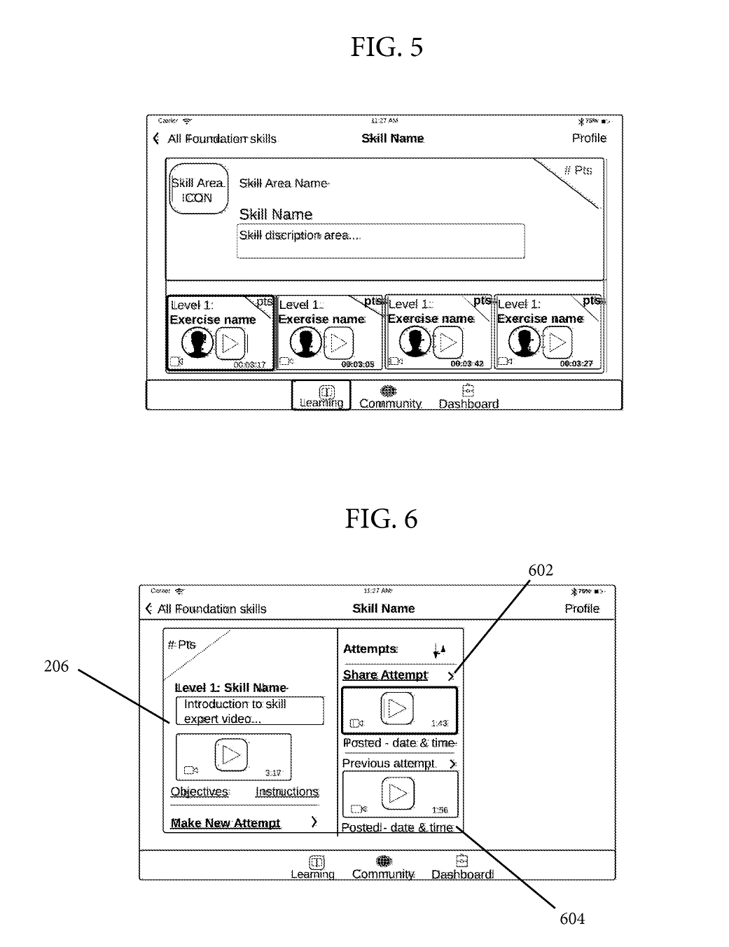

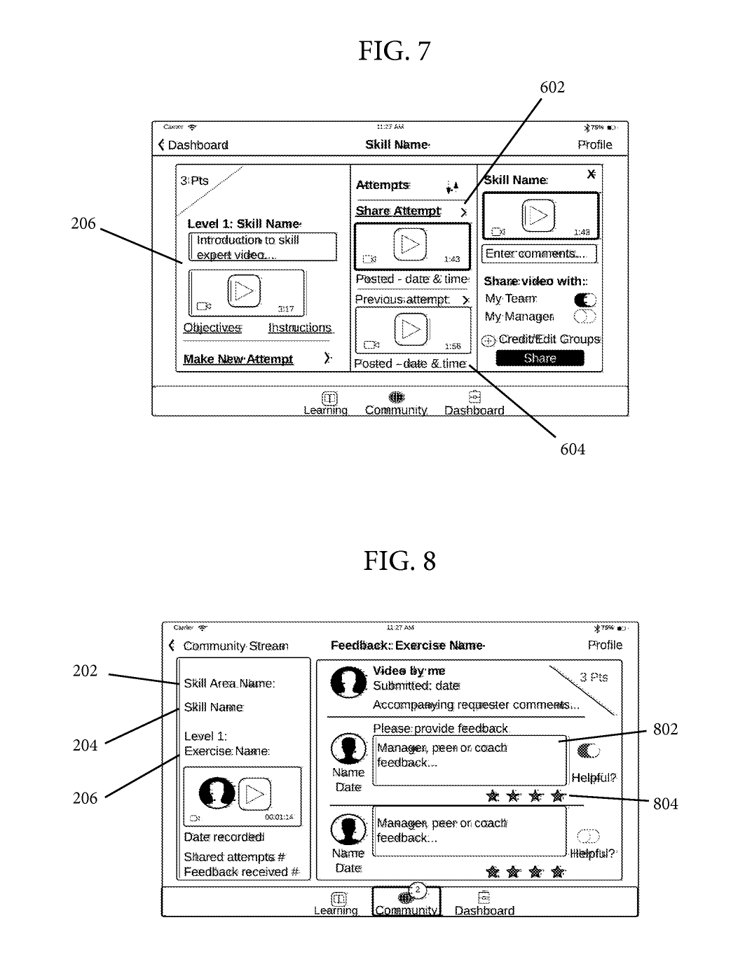

Once the system captures an Attempt, a user can use the system to share this Attempt with other users, as illustrated in FIGS. 4 through 7. When a user decides to share an Attempt, the user can choose a specific exercise, activity, or task 206 within a skill area 204 for which the user has completed tasks, as illustrated in FIG. 4. Once the exercise, activity, or task 206 has been selected, the user can review all of the user's Attempts and decide which of the Attempts the user would like to share, as illustrated in FIG. 5. Once the user selects which Attempt to share, the user will see a summary of the exercise, activity, or task 206, the current Attempt 602 that will be shared, and previous Attempts 604 that have been shared, as illustrated in FIG. 6. Once the user confirms that he or she wants to share the current Attempt 602, the user can choose to share the Attempt with pre-selected users or customizable groups called “Groups,” as illustrated in FIG. 7. The disclosed audiovisual communication and learning management system allows a user's performance on a specific training exercise to be viewed privately by one user or by a group selected by the user. Additionally, the user can make and share subsequent Attempts without being required to register or take part in a full course.

After receiving a shared Attempt from a user, the receiving user or users can then provide an assessment or feedback on the Attempt, as illustrated in FIG. 8. For example, the reviewing user can see the identity of the user creating the Attempt, the broad skill 202, the skill area 204, the exercise, activity, or task 206, or other information associated with the Attempt. The reviewing user can then provide qualitative 802 or quantitative feedback 804. While the Attempts can be shared simultaneously with many users or groups, the feedback can either come back to the submitting user privately or it can be shared broadly with other users. Additionally, the submitting user can receive feedback without being required to register or take part in a full course.

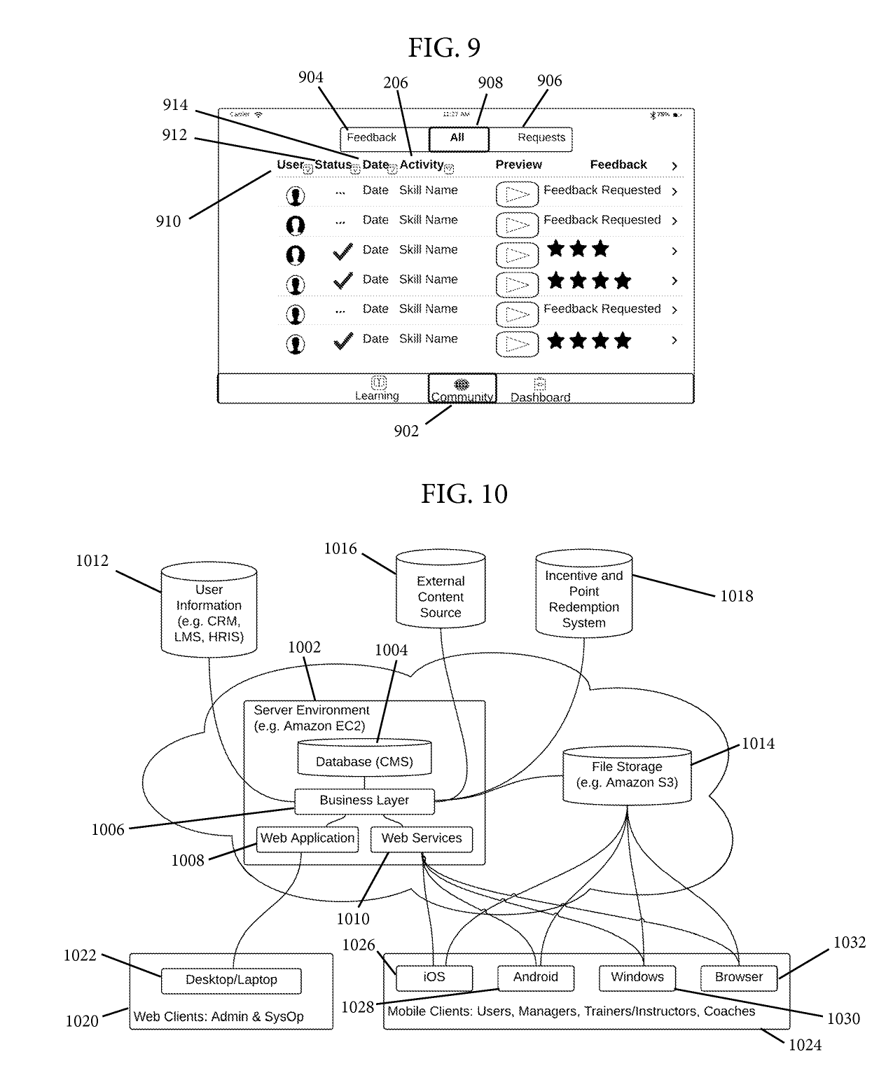

The audiovisual communication and learning management system can organize all Attempts that have been shared by multiple users into a Community screen, as illustrated in FIG. 9. By selecting the Community tab 902, the user can access and view a list of all Attempts on which the user has shared and requested feedback. The user can also view all Attempts someone else has shared with the user. Tabs on the Community screen allow users to manage which Attempts they are viewing. When a user selects Feedback 904, they may see only the Attempts on which they have requested feedback. When a user chooses Requests 906, the user may see only the Attempts others have shared with them. In the All view 908, the user may see all Attempts, and the Attempts in the Feedback 904 and Requests 906 categories can be differentiated by shading or color.

Attempts can be sorted by the receiving user 910, by status of the Attempts 912, by date of the Attempts 914, and by title of the exercises, activities, or tasks 206. Attempts can also be filtered to show only Attempts from specific users or teams, Attempts in a particular status, or Attempts related to specific exercises, activities, or tasks 206 by title.

In the case of providing feedback to others, the user can choose to view an individual Attempt by someone else, which takes them to a Feedback Screen. Here the user can view the individual Attempt, can provide feedback, and can give the Attempt a rating. The feedback provided by the user can be in the form of text, audio, or video. The audiovisual communication and learning management system disclosed herein allows users to provide both qualitative and quantitative assessment of individual Artifacts or Attempts in a way that is private to the user creating the Attempt and the user providing the feedback. The mechanism to capture and display feedback may consist of a form or rubric with one or more factors or criteria that can be evaluated individually or aggregated using weightings or a formula.

In the case of receiving feedback from others on a shared Attempt, the user who submitted an individual Attempt for feedback can touch on the individual Attempt, which takes them to a Feedback Screen where they can see feedback from all users who have provided feedback. On the Feedback Screen, the user can indicate which comments were helpful.

The audiovisual communication and learning management system disclosed herein incorporates gaming principles into the learning process in a way that can increase motivation, usage, and persistence. In one embodiment, the application of gaming principles allows users to get points for engaging with the training system by creating and sharing Attempts. Users can also get points for providing feedback to others, which facilitates further Attempts and, therefore, further improvement on the part of the user creating Attempts. If the recipient marks the feedback as helpful, additional points can be awarded to the user who provided feedback. This design provides motivation based on individual achievement, collaboration, and engagement.

In addition to points being awarded for specific activities such as, but not limited to, sharing Attempts and providing feedback, users can earn points when their Manager or the system (based on specific completion criteria) designates exercises, activities, or tasks 206 as complete. Badges, banners, trophies, and certificates can be awarded for hitting specific milestones within the system. Some badges, banners, trophies, or certificates may also earn bonus points that contribute to a user's overall point totals.

Points that are accumulated through the use of the system can be redeemed for rewards and incentives based on a framework provided by the organization. The application can be connected through an API to a point management, employee incentive, or point redemption system that allows users to exchange points for other goods and services. FIG. 1 illustrates an exemplary user Dashboard with data on skill area 102, skill 104, level 106, status or progression 108, points, and badges 110, banners 112, trophies 114, and certificates.

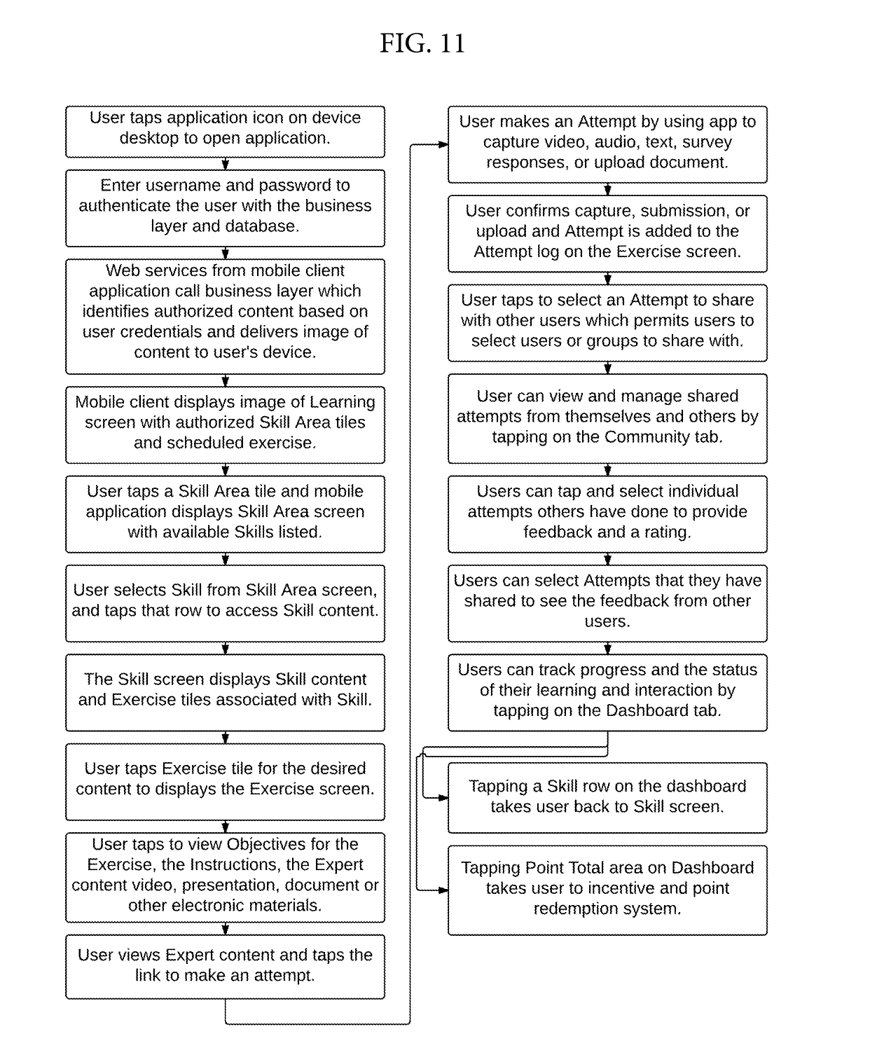

One example of a user's experience with the system is illustrated in FIG. 11, wherein a web client 1020 or mobile client 1024 uses a mobile device or a desktop 1022 to access the disclosed system in the form of a web application 1008 or web services 1010. The user can then enter a username and password to authenticate the user with the business layer 1006 and database 1004. The web services 1010 from the mobile clients 1024 will call the business layer 1006, which identifies authorized content based on the user's credentials. It then delivers images of the systems content from the external content source 1016 to the mobile client's device.

After gaining access to the system, the user will be able to view the learning screen that contains authorized broad skills 206 and scheduled skill areas 204. The user can select a broad skill 206 and the system will display the available skill areas 204. The user can then select a skill area 204 and the system will display the selected skill area 204, after which the user can select an exercise, activity, or task 206 to complete.

Once a user has selected an exercise, activity, or task 206, the system will display objectives for the exercise, activity, or task 206, the instructions, and Expert content such as a video, a presentation, documents, and other electronic materials. After viewing the Expert content, the user can then make an Attempt by capturing video, capturing audio, submitting text, submitting survey responses, or by uploading documents to the system. Once the user confirms this activity, the Attempt can be saved within the system.

After saving an attempt, the user can select an Attempt to share with other users individually or in a group. When the user shares the Attempt, a push notification, text, or email can be generated by the system to notify users with whom the Attempt has been shared that they have received a request for feedback.

After sharing, the user can view and manage shared Attempts by themselves and others by viewing the Community tab 902. The user can then select another user's shared Attempt to provide feedback and a rating. When a user shares feedback on an Attempt created and shared by another user, a push notification, text, or email is generated by the system to notify the receiving user that they have received feedback.

The user can also select personal shared Attempts to view the feedback from other users. To track progress and the status of learning and interaction, the user can view a personal dashboard. Within the dashboard, the user can opt to view a new broad skill 202 or skill area 204 or a user can choose to access the incentive and point redemption system 1018.

In some embodiments, the disclosed system can operate as an enterprise system, wherein an organization, or individuals within an organization, can give certain users an additional role and, therefore, additional access within the system. These expanded roles can include, but are not limited to, Administrators, Managers, and Coaches.

In some embodiments, Managers or Administrators can create, in real-time, specific exercises, activities or tasks 204 that support certain organizational objectives or communication goals. Users can create and share an Attempt in support of these organizational objectives or goals as a way of soliciting input, communication or engagement from other users. Managers and Administrators can track the activity and engagement of users related to these exercises, activities, or tasks 204 in a way that provides knowledge and insight into user acceptance and support of messages, goals, and priorities of the organization.

Additionally, the audiovisual communication and learning management system disclosed herein can be connected through an API to external sources of information about user roles, provisioning profiles, individual identifiers, and other relevant data. Potential external sources can include, but are not limited to, databases and systems such as skill assessment or performance systems, LMSs, CRMs, HRISs, or other e-learning or content registration or scheduling systems.

Based on system configuration, content at all levels can be scheduled and delivered to users based on their individual profiles, pre-assessment results, registration for related courses or training sessions, or assignment by a Manager or Administrator. Individual exercises, activities, or tasks 206 can also be scheduled to be highlighted in the Today's Workout section of the Learning Screen by the Administrator or other authorized user. Alternatively, an external system, such as an LMS, CRM, HRIS, or other proprietary system can use an API to schedule individual exercises, activities, or tasks 206 that should be highlighted. A push notification, text, or email can be generated by the system when new content becomes available in the Today's Workout section.

Further, in one embodiment of the disclosed audiovisual communication and learning management system, Administrators or other authorized users can categorize users by roles, by system-provisioning profiles common across users with certain shared characteristics, or by certain codes or unique identifiers assigned to users. Through the use and combination of roles, provisioning profiles, and individual identifiers, the system can make available, to specific users, certain content, exercises, activities, and tasks stored in the CMS that has been designated for their use. By categorizing users and configuring the system in this way, content at all levels can be scheduled and made available to users based on their individual profiles, pre-assessment results, registration for related courses or training sessions, or individual assignment by a Manager or Administrator. This can include categorization of users and creation of profiles for security purposes or data storage, management and transmission purposes.

Further, administrators or other authorized users can have access to the CMS and can add, modify, or delete broad skills 202, skill areas 204, content types 304, or individual exercises, activities, and tasks 206 and all related content. Additionally, administrators or other authorized users using the CMS can customize branding (for example, company colors), logos (for example, company logos 306), icons, badges 110, banners 112, trophies 114, or other graphical elements displayed to users in the interface.

Managers have access to additional functionality within the system, since a Manager is the “owner” of his or her Team. This designation means that each user can be assigned to a default Group by virtue of the user who is designated by the Administrator as the user's Manager. Managers can access individual Dashboards for users on their team in order to view activity and progress within the system.

The Manager can provide feedback to a user on his or her team. Additionally, a Manager can and assign a rating to a specific Attempt by the user and, if that rating exceeds a designated threshold, the Manager can classify that training exercise as “Complete.” A Manager can also provide private qualitative feedback to a user's specific Attempt.

Another way a Manager can provide feedback to a user is by creating and sharing an exemplary Attempt of a specific exercise, activity, or task 206 in response to a specific Attempt shared by a user. Managers are also able to provide positive recognition to users by providing quantitative ratings of their Attempts in a way that generates points. Additionally, they can share users' Attempts as a way to recognize achievement.

In addition to Administrators and Managers, an organization can classify a user as a Coach within the disclosed system. A Coach has a unique relationship with other users who designate the user as a Coach in their profile. Once a Coach is designated, he or she can show up in a default Group on the sharing screen. The Coach can have the capability to view activity and progress within the system through access to individual Dashboards for users who have designated them as coaches. The Coach can also be configured in the system to act as a Manager and, therefore, have the capability to classify an exercise, activity or task 206 that an Attempt belongs to as Complete by assigning a rating that meets or exceeds a designated threshold.

In some embodiments, instead of manually tracking and evaluating users' attempts, Administrators or other authorized users can configure the system to automatically evaluate Attempts. In some embodiments, automatic evaluation can be completed by using a set rubric or set of evaluation criteria. The system can then provide a rating, provide automated feedback from a feedback library, or assess completion of the exercise, activity, or task 206. In one embodiment of the disclosed audiovisual communication and learning management system, the system could evaluate an Attempt by considering facial recognition, eye movement, vocal fluctuations, bodily movement, keywords, speed of talking, or other factors captured through a still camera, a video camera, or a microphone. A reviewing user's engagement with another user's Attempt can also be evaluated, such as through facial recognition and eye movement. For example, is the reviewing user viewing the Attempt in a meaningful and consistent manner? This could reflect the quality of the Attempt or attest to the quality of the review, or lack thereof.

In addition to monitoring individual users, Managers or other authorized users can configure and view reports in the CMS or mobile application that summarize the type, quantity, and quality of user activity in the system and track certification or milestone attainment. These reports can be consolidated as a management Dashboard of activity and performance for all users or aggregated and summarized by team or role, profile, user characteristic, or organizational characteristic. In addition to other measures, the management Dashboard contains a metric identified as an Engagement Index that measures the relative quantity and quality of user activity in aggregate for a selected group or category of users. The same data and reporting information contained in the management Dashboard can be passed to an LMS, CRM, HRIS, or other proprietary system that an organization can use to track employee development, engagement, or performance through an API.

The audiovisual communication and learning management system disclosed herein allows the Administrator or other authorized users to schedule specific training exercises, activities, or tasks as the featured exercises for a specific day or sequence of days. This allows the organization to guide the focus of the learning and communication on a daily basis through the application itself When new exercises or activities are highlighted for the users in the application, a push notification, text, or email notifies the users that new content or assignments have been posted.

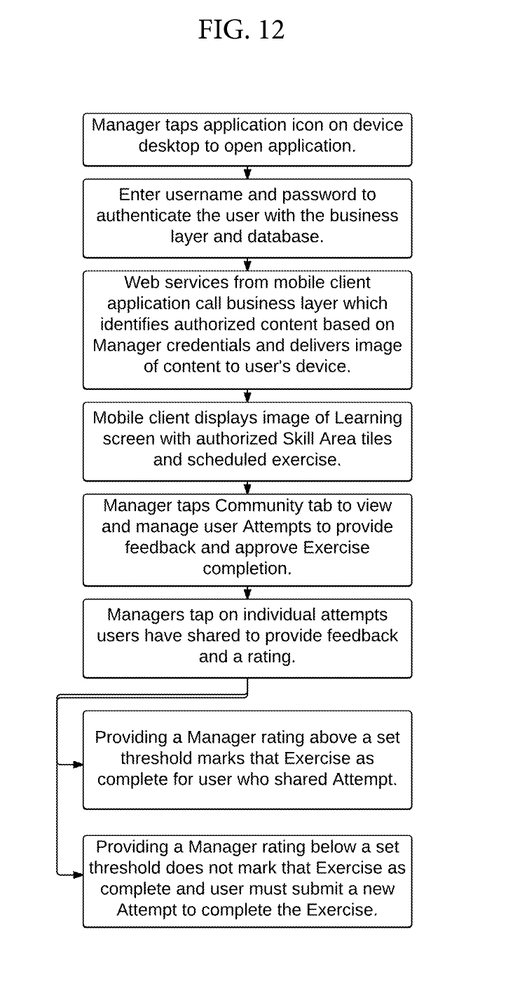

One example of a Manager's experience with the system is illustrated in FIG. 12, wherein the manager uses a mobile device or a desktop 1022 to access the disclosed system. The Manager can then enter a username and password to authenticate the Manager with the business layer 1006 and database 1004. The web services 1010 from the mobile clients 1024 will call the business layer 1006, which identifies authorized content based on the Manager's credentials. It then delivers images of the systems content from the external content source 1016 to the mobile client's device.

After gaining access to the system, the Manager will be able to view the learning screen that contains authorized broad skills 206 and scheduled skill areas 204. The Manager can view and manage shared Attempts by other users by viewing the Community tab 902. For example, the Manager can provide feedback and ratings and to approve completed exercises, activities, or tasks 206. By providing a Manager rating above a set threshold, the system will determine that an exercise, activity, or task 206 has been completed. By providing a Manager rating below a set threshold, the system will determine that an exercise, activity, or task 206 has not been completed and the user will be informed that he or she must submit a new Attempt in order to complete the exercise, activity, or task 206.

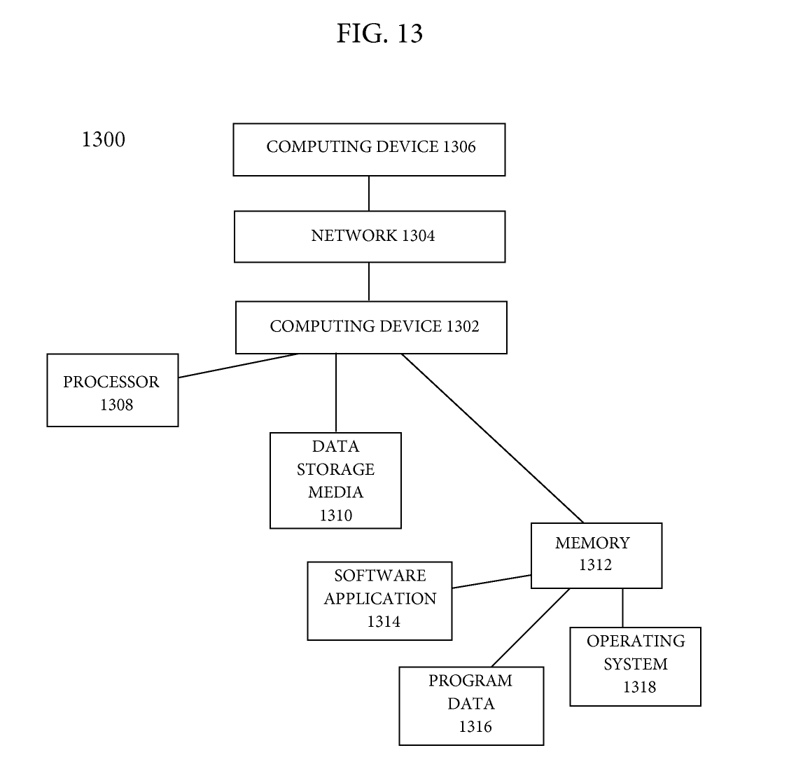

The system described herein uses a computing system to carry out the various functions described herein. FIG. 13 is a schematic block diagram of an example computing system 1300. The example computing system 1300 includes at least one computing device 1302. In some embodiments, the computing system 1300 further includes a communication network 1304 and one or more additional computing devices 1306 (such as a server).

The computing device 1302 can be, for example, located in a user's home or other place of business. In some embodiments, the computing device 1302 is a mobile device. The computing device 1302 can be a stand-alone computing device or a networked computing device that communicates with one or more other computing devices 1306 across a network 1304. The additional computing device(s) 1306 can be, for example, located remotely from the first computing device 1302, but configured for data communication with the first computing device 1302 across a network 1304.

In some examples, the computing devices 1302 and 1306 include at least one processor or processing unit 1308 and system memory 1312. The processor 1308 is a device configured to process a set of instructions. In some embodiments, system memory 1312 may be a component of processor 1308; in other embodiments system memory 1312 is separate from the processor 1308. Depending on the exact configuration and type of computing device, the system memory 1312 may be volatile (such as RAM), non-volatile (such as ROM, flash memory, etc.) or some combination of the two. System memory 1312 typically includes an operating system 1318 suitable for controlling the operation of the computing device 1302, such as the WINDOWS® operating systems or the OS X operating system, or a server, such as Windows SharePoint Server. The system memory 1312 may also include one or more software applications 1314 and may include program data 1316.

The computing device 1302 may have additional features or functionality. For example, the computing device 1302 may also include additional data storage devices 1310 (removable and/or non-removable) such as, for example, magnetic disks, optical disks, or tape. Computer storage media 1310 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 1310 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1302. An example of computer storage media 1310 is non-transitory media.

In some examples, one or more of the computing devices 1302 and 1306 can be located in an establishment, such as a business. In other examples, the computing device 1302 can be a personal computing device that is networked to allow the user to access and utilize the system disclosed herein from a remote location, such as in a user's home, office or other location. In some embodiments, the computing device 1302 is a smartphone, tablet, laptop computer, personal digital assistant, or other mobile device. In some embodiments, system operations and functions are stored as data instructions for a smartphone application. A network 1304 facilitates communication between the computing device 1302 and one or more servers, such as an additional computing device 1306, that hosts the system. The network 1304 may be a wide variety of different types of electronic communication networks. For example, the network 1304 may be a wide-area network, such as the Internet, a local-area network, a metropolitan-area network, or another type of electronic communication network. The network 1304 may include wired and/or wireless data links. A variety of communications protocols may be used in the network 1304 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1306 is a Web server. In this example, the first computing device 1302 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 1308 of the one or more computing devices 1302 or 1306, the instructions cause the processor 1308 to perform one or more of the operations or methods disclosed herein.

While the foregoing disclosure has been described in some detail for purposes of clarity and understanding, it will be appreciated by one skilled in the art from a reading of this disclosure that various changes in form and detail can be made without departing from the true scope of the disclosure and appended claims.

1. A method of managing training exercises comprising:
utilizing a computing device having a processing device and a memory device, the memory device storing instructions that, when executed by the processing device, causes the processing device to:
allow a user access to short duration, non-course-based training exercises through a web-based content management system;
provide the user with a task to complete based on the content provided in the training exercise;
allow the user to share a completed task with other users of the application;
allow the user to request feedback on the completed task from other users;
allow the user to organize and view all completed tasks and feedback on one screen; and
allow the user to privately provide feedback to other users' shared tasks.

2. The method of claim 1, wherein the training exercises support specific skills and competencies.

3. The method of claim 2, wherein the skills and competencies can be organized into specific skill and competency areas.

4. The method of claim 1, wherein the task to complete involves the creation of a video file.

5. The method of claim 1, wherein the task to complete involves the creation of an audio file.

6. The method of claim 1, wherein points are awarded for engaging with the training system.
